(19) United States
(12) Patent Application Publication
(10) Pub. No.: US 2017/0109198 A1
(43) Pub. Date: Apr. 20, 2017

(54) JOB PROCESSING DEVICE, MANAGEMENT SERVER, NON-TRANSITORY COMPUTER-READABLE RECORDING MEDIUM AND MANAGEMENT METHOD

(71) Applicant: KONICA MINOLTA, INC., Tokyo (JP)

(72) Inventor: Yasuaki SUGIMOTO, Tokyo (JP)

(73) Assignee: KONICA MINOLTA, INC., Tokyo (JP)

(21) Appl. No.: 15/284,715

(22) Filed: Oct. 4, 2016

(30) Foreign Application Priority Data
Oct. 16, 2015 (JP) 2015-204959

(51) Int. Cl. G06F 9/48

(52) U.S. Cl. CPC G06F 9/4856

(57) ABSTRACT

Disclosed is a job processing device including: a queue in which jobs are stored; a memory configured to store a program; a network device configured to communicate with an external device via a network; and a processor configured to: sequentially execute the stored jobs by operating in accordance with the stored program, detect another job processing device which operates in accordance with a program having a newer version than the stored program on the network, detect a job in which a quality of a job processing is improved more by being executed by the detected job processing device than by being executed by the job processing device itself, from the stored jobs, and fetch the detected job and transmit the job to the detected job processing device to execute the job by the detected job processing device.

### BACKGROUND OF THE INVENTION

Field of the Invention

The present invention relates to a job processing device in which a program is updated, and a management server, a non-transitory computer-readable recording medium and a management method for managing a plurality of job processing devices.

Description of Related Art

In recent years, in a multi function peripheral (MFP) having various functions, such as a printer, a scanner, a facsimile and the like, generally, programs stored in a flash ROM (Read Only Memory) or the like are updated via a network. For example, the MFP which detects an update program updated in a server, updates the program by downloading the update program.

During the update of the program, the MFP cannot execute a job nor receive an operation. Therefore, the above update of the program is carried out in a so-called standby state, for example, when the MFP does not execute a job or when an operation is not received. For example in case that when the update program is received via the network, an unprocessed job which is in an execution waiting state exists in a queue, the update of the program is suspended until the execution of the job is finished. On the other hand, in case that the program is updated prior to the execution of the job, the execution of the job registered in the queue is suspended until the update of the program is finished.

In Japanese Patent Application Publication No. 2003-54087, the following image processing apparatus is disclosed. In the image processing apparatus, in case that when the update program is received via the network, an unprocessed print job which is in the execution waiting state exists, the print job is transmitted to another image processing apparatus which is connected with the network, and the update of the program is started after the print job is transmitted. Therefore, the update of the program and the execution of the job are carried out soon.

Usually, by updating the program, the quality of the job processing the improvement of the productivity and the like, is improved, such as the elimination of the trouble, the improvement of the image quality. Therefore, when a job which is registered in the queue in the execution waiting state is a job in which the quality of the job processing is improved by the update of the program, it is preferable to carry out the update of the program prior to the execution of the job and to execute the job after the update of the program is finished.

However, in case that the finish of the update of the program is delayed, the start of the execution of the job is also delayed accordingly (for example, several minutes).

In the technology disclosed in Japanese Patent Application Publication No. 2003-54087, the job is transmitted without confirming whether the program has been updated in the apparatus which is the transmission destination of the job. Therefore, in case that the version of the program of the apparatus which is the transmission destination of the job is the previous version and the job to be transmitted is a job in which the quality of the job processing is improved by the update of the program, even if the job is transmitted, the job is executed in the transmission destination of the job without improving the quality of the job processing.

On the other hand, there is a job in which the quality of the job processing is not improved by the update of the program. For example, in case that the program is updated in order to eliminate the trouble relating to the facsimile broadcast transmission, a job in which the quality of the job processing is improved by the update of the program is only a facsimile broadcast transmission job. Even if the other jobs are executed before the update of the program, a problem relating to the quality of the job processing is not caused.

Therefore, when the job in which the quality of the job processing is not improved by the update of the program is also evenly transmitted to another image forming apparatus in order to update the program, the processing load of the image forming apparatus which receives the above job is increased. As a result, there are some cases in which it takes a long time to finish the execution of the job.

### SUMMARY

To achieve at least one of the abovementioned objects, a job processing device reflecting one aspect of the present invention, comprises:

a queue in which one or more jobs are stored;

a memory configured to store a program;

a network device configured to communicate with an external device via a network; and

a processor configured to:

sequentially execute the jobs stored in the queue, by operating in accordance with the program stored in the memory,

detect another job processing device which operates in accordance with a program having a newer version than the program stored in the memory, on the network,

detect a job in which a quality of a job processing is improved more by being executed by the detected another job processing device than by being executed by the job processing device itself, from the jobs stored in the queue, and

fetch the detected job from the queue and transmit the fetched job to the another job processing device via the network device to execute the transmitted job by the another job processing device.

Preferably, the quality of the job processing includes at least one of an occurrence of a trouble, a productivity and an image quality.

Preferably, when a plurality of the detected job processing devices which can be transmission destinations of the detected job are provided on the network, the processor estimates each processing finish estimated time in case that each detected job processing device which can be the transmission destination executes the detected job,

wherein the processor transmits the detected job to the detected job processing device having an earliest processing finish estimated time.

Preferably, the processor is configured to:

calculate a first processing finish estimated time in case that the detected job is transmitted to the another job processing device to execute the transmitted job by the another job processing device and a second processing finish estimated time in case that the detected job is executed by the job processing device itself after the program of the job processing device is updated,

compare the first processing finish estimated time with the second processing finish estimated time,

notify a user of a result of comparing the first processing finish estimated time with the second processing finish estimated time, and receive an option of an execution of the detected job by the job processing device itself or a transmission of the detected job to the another job processing device, from the user, and

transmit the detected job to the another job processing device when the option of the transmission of the detected job is received from the user.

Preferably, the processor is configured to:

calculate a first processing finish estimated time in case that the detected job is transmitted to the another job processing device to execute the transmitted job by the another job processing device and a second processing finish estimated time in case that the detected job is executed by the job processing device itself after the program of the job processing device is updated,

compare the first processing finish estimated time with the second processing finish estimated time, and

transmit the detected job to the another job processing device when the first processing finish estimated time is earlier than the second processing finish estimated time.

Preferably, the processor is configured to:

update the program stored in the memory when the processor does not execute the job, and

detect the job in which the quality of the job processing is improved by being executed by the detected another job processing device, when an update of the program is delayed by executing the job.

Preferably, when the job processing device itself executes the job in which the quality of the job processing is improved by being executed after the program is updated, the processor updates the program after the processor executes all of the jobs stored in the queue except the job in which the quality of the job processing is improved by being executed after the program is updated.

Preferably, when the job processing device executes a job which is received from a second another job processing device which operates in accordance with a program having an older version than the program stored in the memory, the processor detects a second job in which the quality of the job processing is not deteriorated more by being executed by the second another job processing device than by being executed by the job processing device itself, from the jobs stored in the queue, and

the processor fetches the detected second job from the queue and transmits the fetched second job to the second another job processing device via the network device to execute the transmitted second job by the second another job processing device.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing the configuration of the print system according to the first embodiment;

FIG. 2 is a block diagram showing the schematic configuration of the multi function peripheral according to the first embodiment;

FIG. 3 is a block diagram showing the functional configuration of the multi function peripheral, which relates to the execution and the transmission of the job;

FIG. 4 is a block diagram showing the schematic configuration of the management server;

FIG. 5 is a view showing an example of the management table stored in the management server;

FIG. 6 is a view showing an example of the update management table stored in the management server;

FIG. 7 is a view showing the state of each queue of MFP1 and MFP2 before the jobs are transmitted;

FIG. 8 is a view showing the situation in which the jobs to be improved (FAX broadcast transmission jobs) are transmitted from MFP1 to MFP2;

FIG. 9 is a view showing the state of each queue of MFP1 and MFP2 after the jobs to be improved are transmitted;

FIG. 10 is a view showing the situation in which the irrelevant job (FAX transmission job) is transmitted from MFP2 to MFP1;

FIG. 11 is a view showing the state of each queue of MFP1 and MFP2 after the irrelevant job is transmitted;

FIGS. 12 to 14 are a flowchart showing the process for transmitting the job to be improved and/or the irrelevant job by the multi function peripheral;

FIG. 15 is a flowchart showing the process carried out by the management server so as to correspond to the process of the multi function peripheral, which is shown in FIGS. 12 to 14;

FIG. 16 is a view showing the change in the state of the queue in case that the program is updated after the job order is changed in the queue;

FIG. 17 is a flowchart showing the process of the management server according to the second embodiment;

FIG. 18 is a flowchart showing the detail of the first job transmission process (Step S304 in FIG. 17); and

FIG. 19 is a view showing an example of the job transmission in case that three MFPs in which the programs having the version numbers of 1, 2 and 3 are installed respectively, are provided.

### DETAILED DESCRIPTION OF PREFERRED EMBODIMENTS

Hereinafter, preferred embodiments of the present invention will be explained with reference to the accompanying drawings.

### First Embodiment

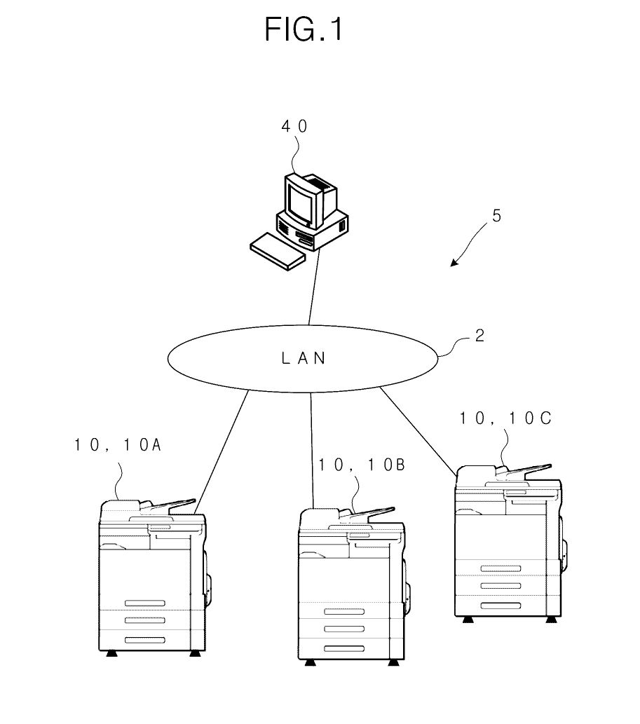

FIG. 1 shows the print system 5 according to the first embodiment. The print system 5 comprises a plurality of multi function peripherals 10A, 10B and 10C each of which functions as the job processing device according to the first embodiment and a management server 40, which are connected with each other via a network 2, such as a LAN (Local Area Network) so as to be communicable to each other. Hereinafter, in case that a plurality of multi function peripherals 10A, 10B and 10C are comprehensively referred, or in case that any one of the multi function peripherals is referred, the reference numeral which is indicated by only the numeral without attaching the alphabetical mark, is used, such as “multi function peripheral(s) 10”. In case that each of the multi function peripherals is referred, the reference numeral which is indicated by the numeral and the alphabetical mark (A, B, C or the like) attached thereto, is used, such as “multi function peripheral 10A, 10B or 10C”. In case the individual elements and the like of the multi function peripheral 10 are referred, the reference numeral which is indicated as described above is similarly used.

The multi function peripheral (also referred to as “MFP”) 10 has the function for executing various types of jobs, such as a copy job for printing an image of an original on a recording sheet by optically reading the original, a scan job for storing the image data of the read original as a file or transmitting the file to an external terminal via the network, a print job for printing out an image on a recording sheet in accordance with the data received from a PC, and the like.

The multi function peripheral 10 stores the programs for controlling the operation of the multi function peripheral 10. In the management server 40, the programs used in the multi function peripheral 10 and having different versions from each other are stored. In the management server 40, the upgraded program (update program) is uploaded by an administrator or the like and is stored.

The multi function peripheral 10 has the function for updating (upgrading) the stored program to the update program by downloading the update program which is uploaded in the management server 40, from the management server 40 via the network 2. By updating the program, the quality of the job processing is improved, such as the elimination of the trouble, the improvement of the image quality, the improvement of the productivity and the like. The productivity includes the number of sheets for which the copy, the print or the scan can be executed for one minute, and the like. Further, in case of a copy job, the productivity includes the shortening of the FCOT (First Copy Output Time: time taken to copy an image on the first sheet).

Because the update of the program is not simultaneously carried out for all of the multi function peripherals 10 on the network 2, there is some possibility that the versions of the programs are different among a plurality of multi function peripherals 10 connected with the network 2. Therefore, according to the multi function peripheral 10 of the first embodiment (in this paragraph, referred to as “one multi function peripheral 10”), when another multi function peripheral 10 which operates in accordance with the program having a newer version than the program installed in one multi function peripheral 10, is provided on the network 2, one multi function peripheral 10 judges whether the job to be improved exists in the jobs which are in the execution waiting state in one multi function peripheral 10. The job to be improved is a job in which the quality of the job processing is improved more by being executed by another multi function peripheral 10 which operates in accordance with the program having the newer version, than by being executed by one multi function peripheral 10 itself. Then, in case that the job to be improved exists, one multi function peripheral 10 transmits the job to be improved to another multi function peripheral 10 which operates in accordance with the program having the newer version to instruct another multi function peripheral 10 to execute the job to be improved.

In general, it takes several to several tens of minutes to update the program in the multi function peripheral 10. In case that after the program of the multi function peripheral 10 is updated, the multi function peripheral 10 executes the job to be improved, which is in the execution waiting state, a long standby time required for the execution of the job is caused. In this embodiment, because the job to be improved is transmitted to another multi function peripheral 10 which operates in accordance with the program having the newer version to instruct another multi function peripheral 10 to execute the job to be improved, it is possible to execute the job with high quality sooner by effectively using another multi function peripheral 10 without waiting for the update of the program of the multi function peripheral 10.

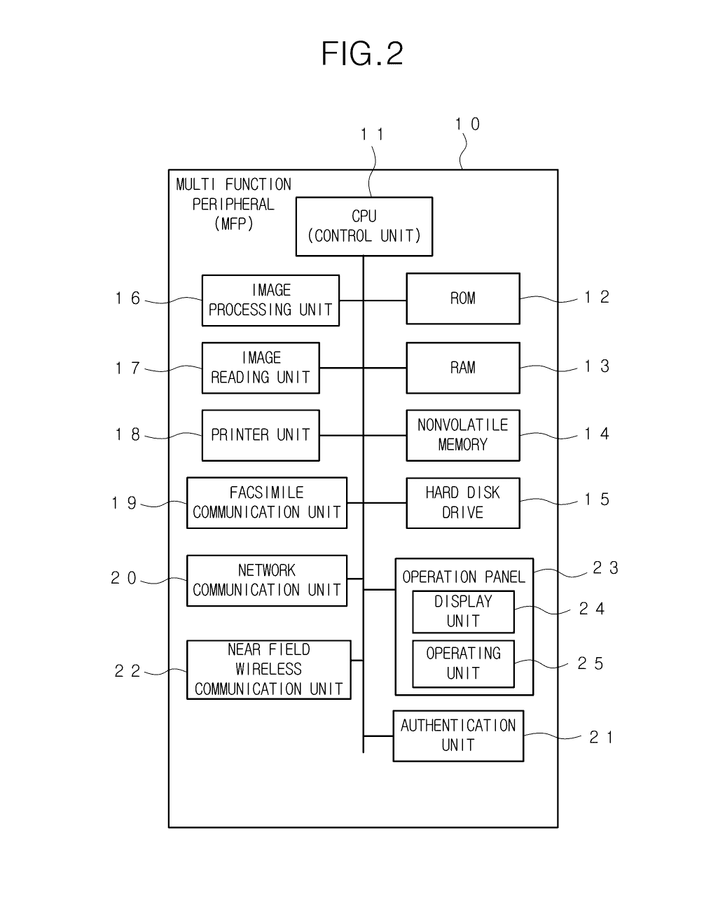

FIG. 2 is a block diagram showing the schematic configuration of the multi function peripheral 10 according to the first embodiment. The multi function peripheral 10 comprises a CPU (Central Processing Unit) 11 for entirely controlling the operation of the above multi function peripheral 10. The CPU 11 is connected with a ROM 12, a RAM (Random Access Memory) 13, a nonvolatile memory 14, a hard disk drive 15, an image processing unit 16, an image reading unit 17, a printer unit 18, a facsimile communication unit 19, a network communication unit 20, an authentication unit 21, a near field wireless communication unit 22, an operation panel 23 and the like via a bus.

By the CPU 11, a middleware, application programs and the like are executed on an OS (Operating System) program as a base. In the ROM 12, the program for starting up the multi function peripheral 10 is stored. After the multi function peripheral 10 is started up in accordance with the above program, the programs stored in the hard disk drive 15 are loaded on the RAM 13. By executing various types of processes by the CPU 11 in accordance with the loaded programs, each function of the multi function peripheral 10 is realized.

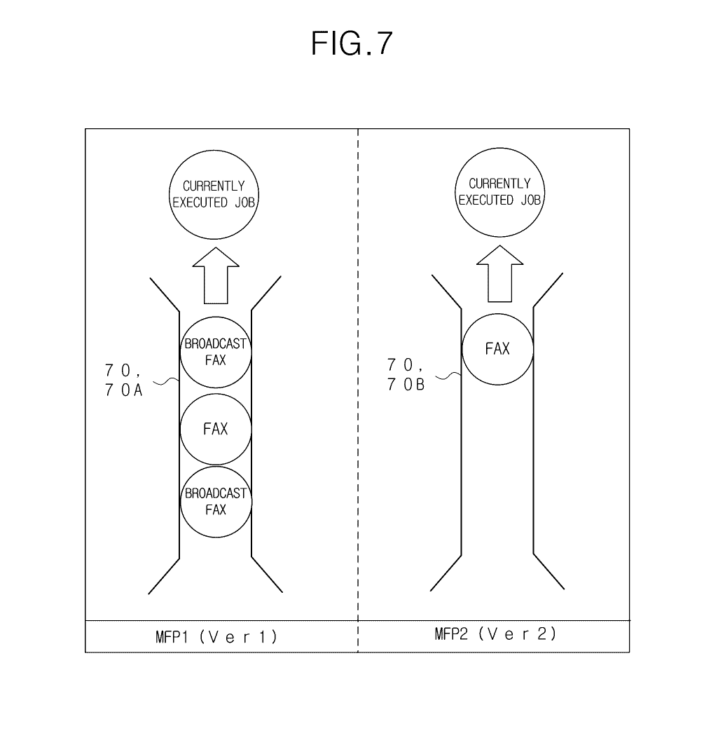

The RAM 13 is used as a work memory for temporarily storing various data when the CPU 11 executes the process in accordance with the programs, and as an image memory for storing image data. In the RAM 13, the queue 70 (See FIG. 7 and the like) for storing the input jobs in the input order is provided. The queue 70 is a FIFO (first in/first out) type of memory.

The CPU 11 of the multi function peripheral 10 enters the input job at the tail of the queue 70. When the multi function peripheral 10 is in the job executable state, the CPU 11 fetches the job which exists at the head of the queue 70 and executes the fetched job. After the execution of this job is finished, the CPU 11 fetches the next job from the head of the queue 70 and executes the fetched job. In case that when the execution of the job is finished, the job does not exist in the queue 70, the multi function peripheral 10 is in the standby state.

The nonvolatile memory 14 is a memory (flash memory) in which the stored contents are not damaged even if the multi function peripheral 10 is turned off, and is used for storing various types of settings.

The hard disk drive 15 is a large-capacity nonvolatile memory device. In the hard disk drive 15, an OS program, various types of application programs, user information, various types of job histories and the like are stored. Further, in the hard disk drive 15, the program for executing a series of the control for the multi function peripheral 10 by the CPU 11 (the program for controlling the operation of the job processing in the multi function peripheral 10, and the like) is stored. The above program is overwritten by the update program which is downloaded from the management server 40 and is updated. The hard disk drive 15 may be another type of storing medium, such as SSD (Solid State Drive).

The image processing unit 16 carries out the rasterizing process for converting print data into image data, the compression/decompression process for the image data, and the like in addition to the processings, such as the enlargement/reduction or the rotation of image data.

The image reading unit 17 has the function for obtaining image data by optically reading an image of an original. For example, the image reading unit 17 comprises a light source for irradiating an original with light, a line image sensor for reading the original line by line in the width direction of the original by receiving the reflected light from the original, a moving unit for sequentially moving the reading position line by line in the longitudinal direction of the original, an optical system having lenses, mirrors, and the like for guiding the reflected light from the original to the line image sensor and focusing the reflected light on the line image sensor, a converting unit for converting an analog image signal outputted from the line image sensor into digital image data, and the like.

The printer unit 18 has the function for forming an image on the recording sheet in accordance with the image data. In this embodiment, the printer unit 18 is configured as a so-called laser printer which comprises a conveying device for the recording sheet, a photoconductive drum, a charging device, a laser unit, a developing device, a transfer and separation device, a cleaning device and a fixing device, and which forms an image by the electrophotographic process. Alternatively, an image may be formed by another type of printer.

The facsimile communication unit 19 has the function for transmitting and receiving the image data to/from an external device having the facsimile (FAX) function via a public line.

The network communication unit 20 has the function for executing the data communication with the management server 40, another external device and the like via the network 2, such as LAN.

The authentication unit 21 has the function for carrying out the user authentication. Specifically, when the user is logged in, the authentication unit 21 carries out the user authentication and identifies the login user. In this embodiment, the login is required to use the operating unit 25, and the user authentication is necessarily carried out before the multi function peripheral 10 is used. The method for carrying out the user authentication may be an optional suitable method, such as the authentication using the user ID (Identification) and the password, fingerprint authentication or the like.

The near field wireless communication unit 22 carries out the near field wireless communication with an external terminal, such as a portable terminal. The communicable range is, for example, within about 10 cm or the like.

The operation panel 23 comprises the display unit 24 and the operating unit 25. The operating unit 25 comprises a hardware switch unit, such as a start button, a return button and the like, and a touch panel. The touch panel is provided on the display unit 24, and detects the touch position (coordinate position) on which the display screen of the display unit 24 is pressed down by a touch pen, the user's finger or the like. The display unit 24 comprises a liquid crystal display (LCD) and the like, and has the function for displaying various types of operation windows, setting windows and the like.

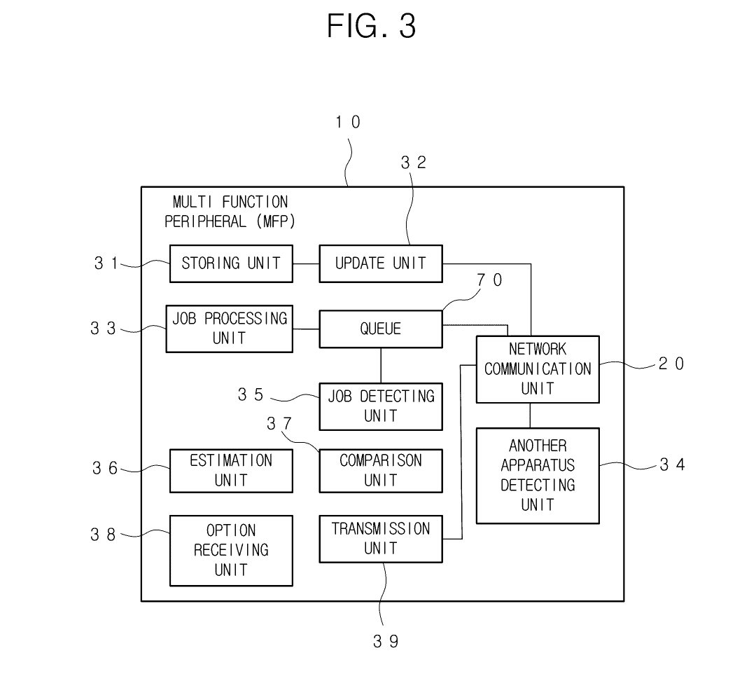

FIG. 3 is a block diagram showing the functional configuration of the multi function peripheral 10, which relates to the execution and the transmission of the job. These functions are realized by operating each hardware unit of the multi function peripheral 10 in accordance with the execution of the programs by the CPU 11. The multi function peripheral 10 has each function of a storing unit 31, an update unit 32, the queue 70, a job processing unit 33, the network communication unit 20, an another apparatus detecting unit 34, a job detecting unit 35, an estimation unit 36, a comparison unit 37, an option receiving unit 38, a transmission unit 39 and the like.

The update unit 32 updates the program stored in the storing unit 31 to the program having a new version, which is downloaded from the management server 40. The job processing unit 33 sequentially executes the jobs registered in the queue 70 by operating in accordance with the program stored in the storing unit 31. The update unit 32 updates the program of the multi function peripheral 10 when the job processing unit 33 does not execute the job.

The another apparatus detecting unit 34 detects another multi function peripheral 10 which operates in accordance with the program having a newer version than the program stored in the storing unit 31. The job detecting unit 35 detects the job to be improved, in which the quality of the job processing is improved more by being executed by another multi function peripheral 10 detected by the another apparatus detecting unit 34, than by being executed by the multi function peripheral 10 itself, from the jobs stored in the queue 70.

When there are a plurality of multi function peripherals 10 which can be the transmission destinations of the job to be improved, which is detected by the job detecting unit 35, the estimation unit 36 estimates each processing finish estimated time in case that each multi function peripheral 10 which can be the transmission destination executes the detected job to be improved. The comparison unit 37 compares the processing finish estimated time in case that the detected job to be improved is transmitted to another multi function peripheral 10 and is executed by another multi function peripheral 10, with the processing finish estimated time in case that the detected job to be improved is executed by the multi function peripheral 10 itself after the program stored in the storing unit 31 is updated. The option receiving unit 38 notifies a user of the result of the above comparison, and receives the option of the execution of the detected job by the multi function peripheral 10 itself or the transmission of the detected job to another multi function peripheral 10, from the user.

When the option receiving unit 38 receives the option of the transmission of the detected job from the user, the transmission unit 39 transmits the detected job to be improved to another multi function peripheral 10 (another job processing device). Further, in case that the mode in which the multi function peripheral 10 automatically selects the option of the execution of the detected job by the multi function peripheral 10 itself or the transmission of the detected job without receiving the option from the user, is set, the transmission unit 39 transmits the job to be improved to the transmission destination when the processing finish estimated time in case of the transmission of the job is earlier than the processing finish estimated time in case of the execution of the job by the multi function peripheral 10 itself.

In the situation in which the update of the program is requested, but because the job is currently executed, the update of the program cannot be carried out and is delayed, the multi function peripheral 10 operates as follow. The job processing unit 33 executes the job in which the quality of the job processing is not changed even if the program is updated, prior to the job in which the quality of the job processing is improved by the update of the program, among the jobs stored in the queue 70. The update unit 32 updates the program when the execution of all of the jobs in which the quality of the job processing is not changed by the update of the program is finished. Then, the job processing unit 33 executes the job in which the quality of the job processing is improved by the update of the program.

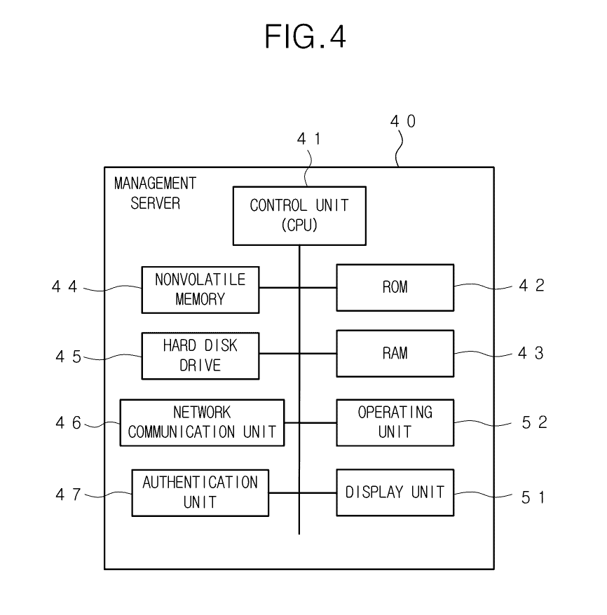

FIG. 4 is a block diagram showing the schematic configuration of the management server 40. The management server 40 comprises a CPU 41 for entirely controlling the operation of the above management server 40. The CPU 41 is connected with a ROM 42, a RAM 43, a nonvolatile memory 44, a hard disk drive 45, a network communication unit 46, an authentication unit 47, a display unit 51, an operating unit 52 and the like via a bus.

By the CPU 41, a middleware, application programs and the like are executed on an OS program as a base. In the ROM 42, various types of programs are stored. By executing various types of processes by the CPU 41 in accordance with the above programs, each function of the management server 40 is realized.

The RAM 43 is used as a work memory for temporarily storing various data when the CPU 41 executes the process in accordance with the programs.

The nonvolatile memory 44 is a memory (flash memory) in which the stored contents are not damaged even if the management server 40 is turned off, and is used for storing various types of settings.

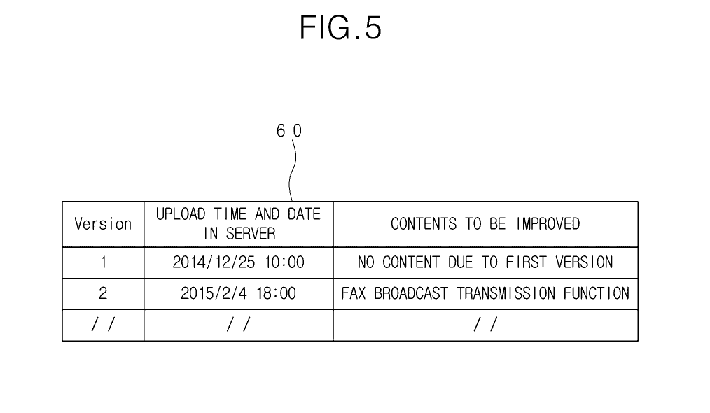

The hard disk drive 45 is a large-capacity nonvolatile memory device. In the hard disk drive 45, an OS program, various types of application programs and the like are stored. Further, the update programs having various versions, which are uploaded by an administrator or the like are stored. Moreover, the management table 60 (See FIG. 5) in which the information, such as the version of the current program of each of the managed multi function peripherals 10 which are connected with the management server 40 via the network 2, the contents to be improved by the program having each version, and the like is registered, is stored.

The network communication unit 46 has the function for executing the data communication with the multi function peripherals 10, another external device and the like via the network 2.

The authentication unit 47 has the function for carrying out the user authentication. The operating unit 52 comprises an input device, such as a keyboard, a mouse and the like. The display unit 51 is a display device, such as a liquid crystal display or the like, and has the function for displaying various types of operation windows, setting windows and the like.

The management server 40 stores and manages the uploaded programs. Further, when the request for downloading the program is received from the multi function peripheral 10 connected via the network 2, the management server 40 transmits the requested program to the multi function peripheral 10 which transmits the above request. The management server 40 manages the version of the program which is currently used by each managed multi function peripheral 10.

Next, the management table 60 stored in the management server 40 will be explained.

FIG. 5 shows an example of the management table 60 stored in the management server 40. In the management table 60, the history of the programs uploaded in the management server 40 is registered.

Specifically, the version number of each uploaded program, the date and time at which each program is uploaded and the contents to be improved by each program are registered. In general, because the quality of the job processing is improved, such as the elimination of the trouble, the improvement of the image quality, the improvement of the productivity and the like, by the update of the program, the contents to be improved are registered as the information of the program having each version.

In the management server 60 shown in FIG. 5, the program having the version number of 2 (version 2) is uploaded after the program having the version number of 1 (version 1) is uploaded. The version 2 is a program for eliminating the trouble relating to the facsimile broadcast transmission.

From the contents to be improved by the version 2, it is recognized that the trouble relating to the facsimile broadcast transmission is caused by the previous program (in this example, the version 1). That is, when the facsimile broadcast transmission job is executed by the multi function peripheral 10 which operates in accordance with the version 1, there is a risk that the trouble is caused. On the other hand, when the facsimile broadcast transmission job is executed by the multi function peripheral 10 which operates in accordance with the version 2, there is no risk that the trouble is caused (the quality of the job processing is improved in the facsimile broadcast transmission job). Further, with respect to the jobs except the facsimile broadcast transmission job, for example, the facsimile transmission job, even if the job is executed by the multi function peripheral 10 which operates in accordance with the version 1 or by the multi function peripheral 10 which operates in accordance with the version 2, there is no risk that the trouble is caused (the quality of the job processing is not changed).

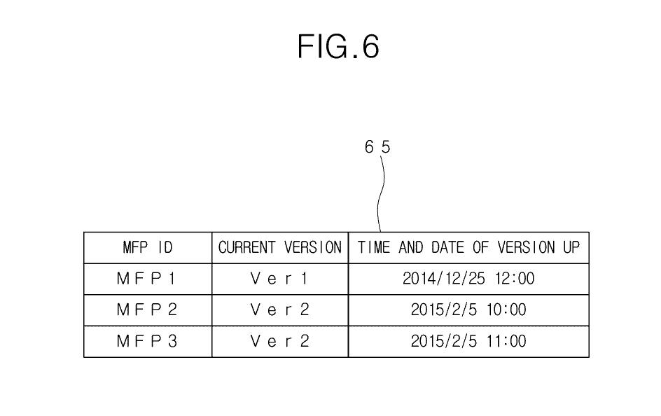

FIG. 6 shows the update management table 65 stored in the management server 40. In the update management table 65, the version number of the program which is currently used by each multi function peripheral 10 managed by the management server 40 and the date and time at which the program of each multi function peripheral 10 managed by the management server 40 is updated to the program having the current version, are registered. When the management server 40 is notified of the finish of the install of the update program from the multi function peripheral 10 which downloads the above update program, the management server 40 updates the registered contents relating to the current version of the program of the above multi function peripheral 10 in the update management table 65.

Next, the operation of the multi function peripheral 10 in which the jobs are registered in the queue 70, will be explained.

When another multi function peripheral 10 which operates in accordance with the program having a newer version (referred to as the update program) than the program stored in one multi function peripheral 10, is provided on the network 2, one multi function peripheral 10 judges whether the job to be improved exists in the queue 70. The job to be improved is a job in which the quality of the job processing is improved more by being executed by another multi function peripheral 10 which operates in accordance with the update program, than by being executed by one multi function peripheral 10 itself. In case that the job to be improved exists, one multi function peripheral 10 fetches the job to be improved from the queue 70 and transmits the job to be improved to another multi function peripheral 10 which operates in accordance with the update program to instruct another multi function peripheral 10 to execute the job to be improved.

FIG. 7 shows each state of the queues 70A and 70B before the jobs to be improved are transmitted. The first multi function peripheral 10 (MFP1) operates in accordance with the version 1 (old program). The second multi function peripheral 10 (MFP2) operates in accordance with the version 2 (update program).

MFP1 currently executes the job. In the queue 70A of MFP1, three jobs are registered in the order of (1) the facsimile broadcast transmission job as the job to be improved, in which the quality of the job processing is improved by being executed by MFP2 which operates in accordance with the update program, (2) the facsimile transmission job which is a job in which the quality of the job processing is not changed even by being executed by MFP1 which operates in accordance with the old program or by MFP2 which operates in accordance with the update program (the above job is referred to as the irrelevant job), and (3) the facsimile broadcast transmission job as the job to be improved.

MFP2 currently executes the job. In the queue 70B of MFP2, the facsimile transmission job as the irrelevant job is registered. However, in this embodiment, it is not required that MFP2 currently execute the job. Further, it is not required that the job is registered in the queue 70B.

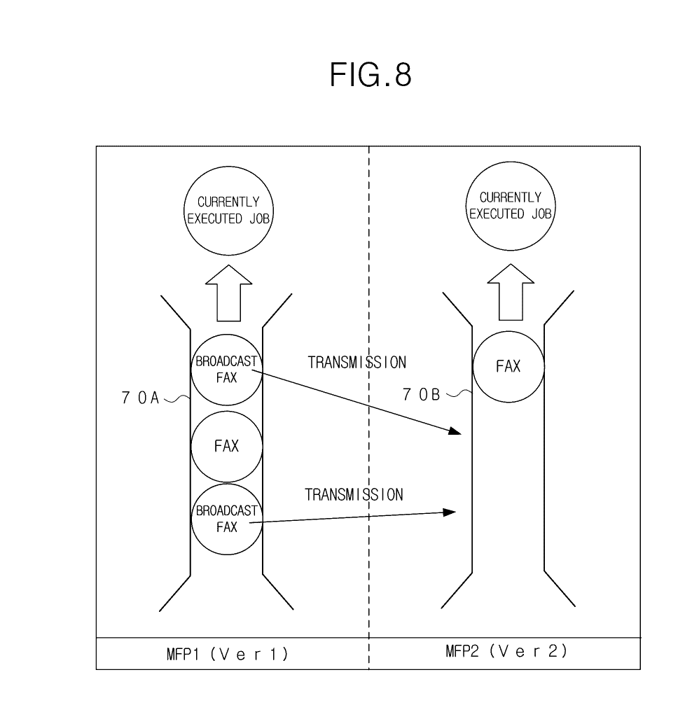

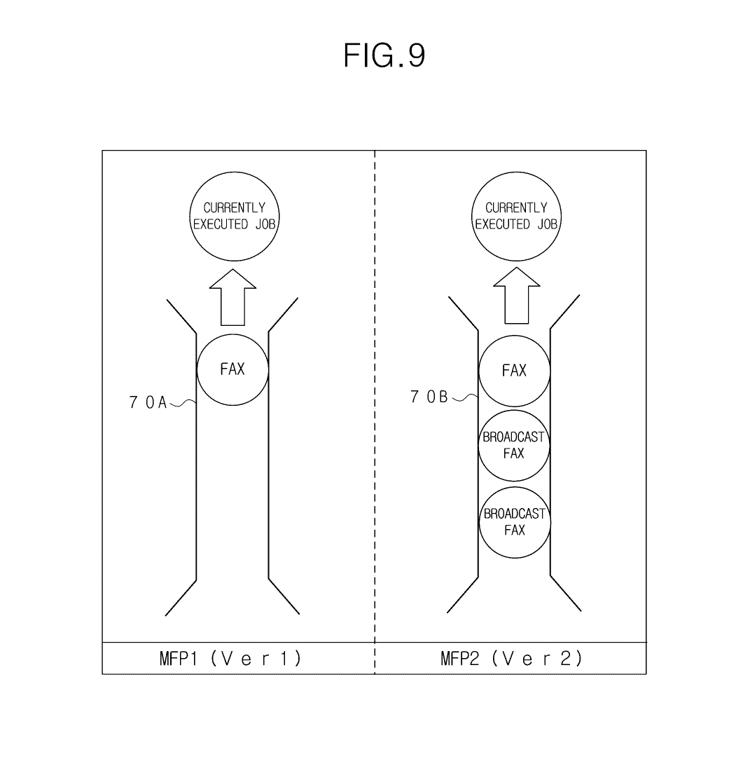

At this time, as shown in FIG. 8, MFP1 transmits two facsimile broadcast transmission jobs registered in the queue 70A as the job to be improved, to MFP2. FIG. 9 shows the situation after the transmission of the jobs. After MFP1 finishes the execution of the job which was being executed, MFP1 executes the facsimile transmission job registered in the queue 70A without updating the program. Then, in case that all of the jobs registered in the queue 70A have been executed, MFP1 starts the update process for updating the stored program to the update program.

MFP2 which receives the transmitted jobs registers the transmitted jobs in the queue 70B in the order of the transmission. Then, MFP2 executes the jobs in the order from the head of the queue 70B. Therefore, the facsimile broadcast transmission jobs (jobs to be improved) transmitted from MFP1 to MFP2 are executed by MFP2 which operates in accordance with the update program in the situation in which the quality of the job processing is improved. That is, without waiting for the finish of the update of the program in MFP1, the job to be improved can be executed sooner in the situation in which the quality of the job processing is improved.

Next, the operation in which the multi function peripheral 10 which operates in accordance with the update program transmits the irrelevant job to the multi function peripheral 10 which operates in accordance with the old program, will be explained.

In case that the irrelevant job in which the quality of the job processing is not changed even by being executed by the multi function peripheral 10 which operates in accordance with the update program or by the multi function peripheral 10 which operates in accordance with the old program, is registered in the queue 70 of the multi function peripheral 10 which already operates in accordance with the update program, the above irrelevant job is transmitted to another multi function peripheral 10 which operates in accordance with the old program, to instruct it to execute the above irrelevant job.

Only in case that MFP2 which operates in accordance with the update program receives the job to be improved, from MFP1 which operates in accordance with the old program, MFP2 may transmit the irrelevant job to MFP1. That is, by transmitting the job from MFP1 to MFP2, the number of the jobs which are in the execution waiting state in MFP2 is increased and the processing load of the MFP2 is increased. Therefore, only in case that MFP2 receives the job to be improved from MFP1 which operates in accordance with the old program, the irrelevant job is transmitted from MFP2 to MFP1.

In this case, it is preferable that the number of jobs to be transmitted from MFP2 to MFP1 is limited to the number of jobs to be received by MFP2 from MFP1, or less. Alternatively, it is preferable that the number of jobs to be transmitted from MFP2 to MFP1 is limited so as to set the processing load or the processing time for processing the jobs to be transmitted from MFP2 to MFP1, to the processing load or the processing time for processing the jobs to be received by MFP2 from MFP1, or less.

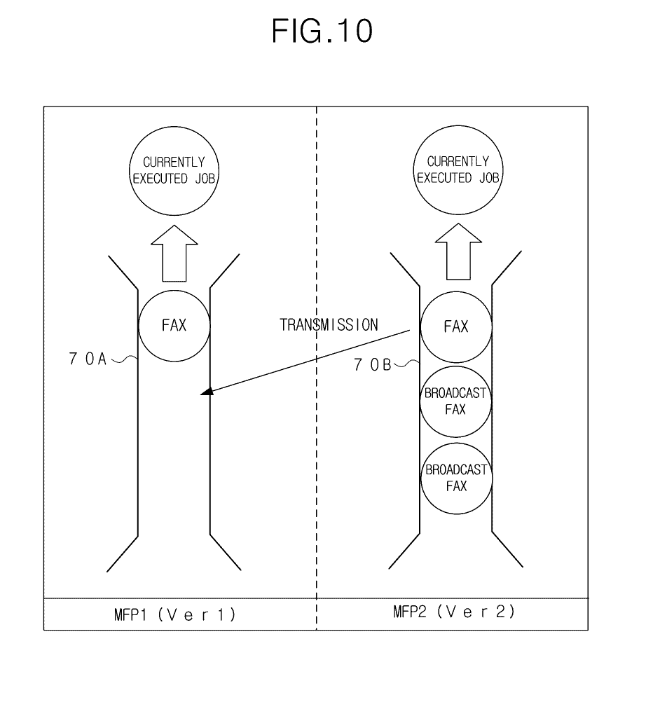

FIG. 10 shows an example of each state of the queues 70A and 70B in case that the irrelevant job is transmitted from MFP2 to MFP1. MFP2 checks whether the irrelevant job is registered in the queue 70B of MFP2. When the irrelevant job is registered in the queue 70B of MFP2, MFP2 transmits the above irrelevant job to MFP1. In the example of FIG. 10, because the facsimile transmission job is registered as the irrelevant job in the queue 70B of MFP2, MFP2 fetches the facsimile transmission job from the queue 70B of MFP2 and transmits the fetched job to MFP1.

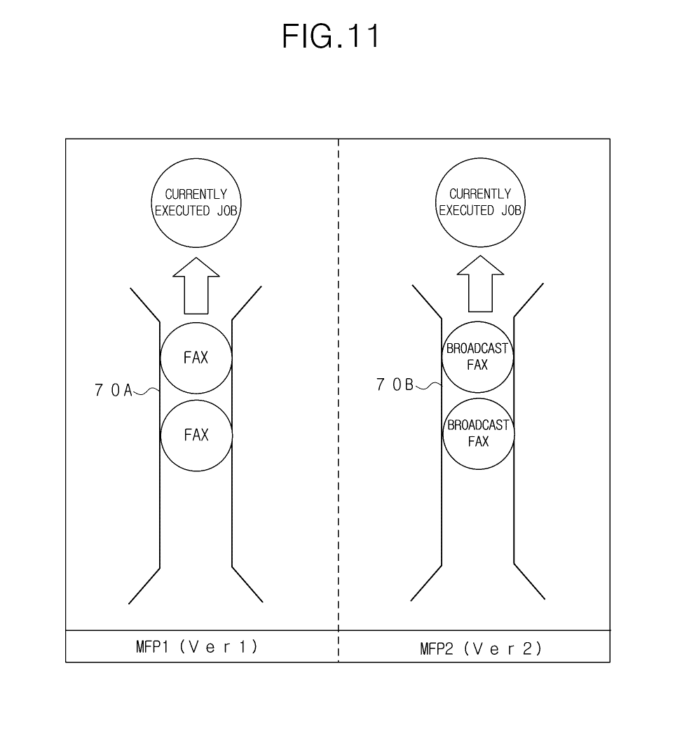

As shown in FIG. 11, MFP1 registers the facsimile transmission job in the queue 70A, which is transmitted as the irrelevant job from the MFP2, and sequentially executes the jobs registered in the queue 70A, in accordance with the old program. MFP2 sequentially executes the jobs which remain in the queue 70B.

As described above, the job to be improved is transmitted to MFP2 which operates in accordance with the update program and is executed by MFP2. The irrelevant job is transmitted to MFP1 which operates in accordance with the old program and is executed by MFP1. Therefore, the processing load of each MFP is averaged, and the execution of the jobs is finished soon in the whole system.

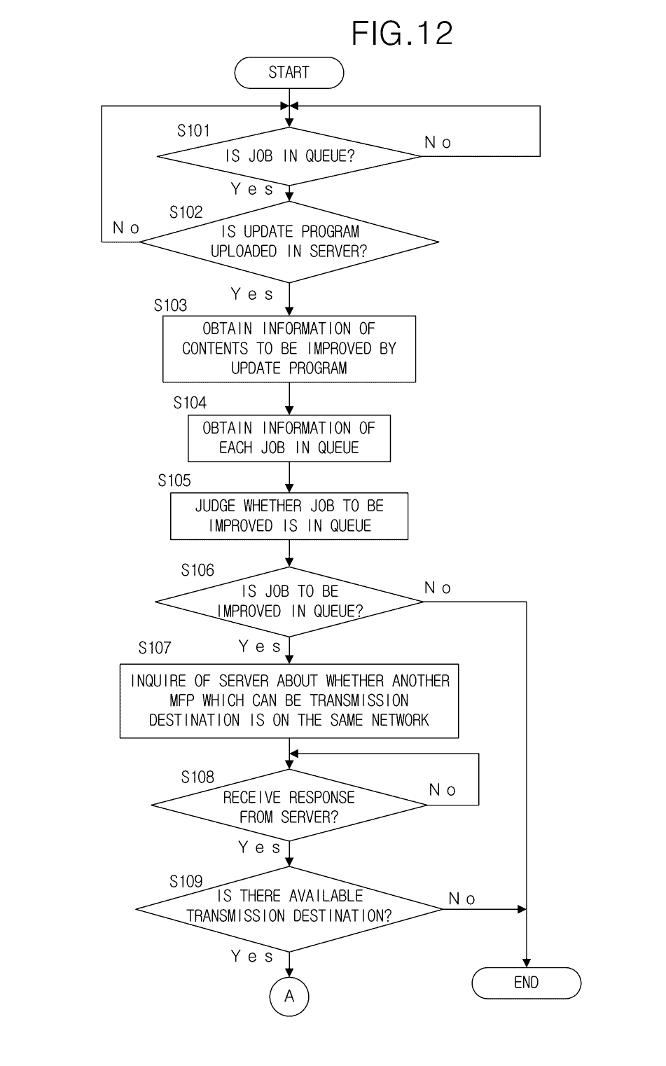

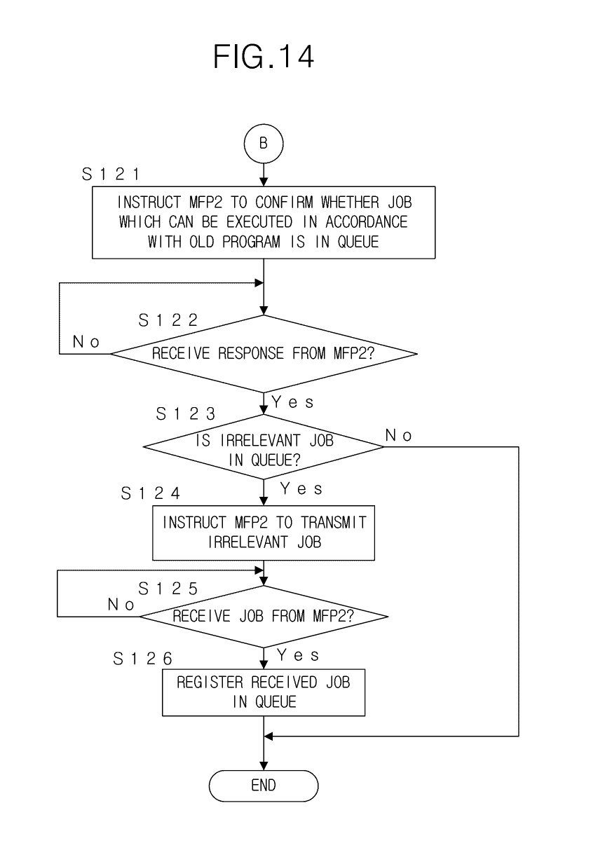

FIGS. 12 to 14 show the process for transmitting the job to be improved and/or the irrelevant job by the multi function peripheral 10. The multi function peripheral 10 (referred to as “MFP1” as necessary) checks whether the job exists in the queue 70 thereof (Step S101). When the job exists in the queue 70 (Step S101; Yes), the multi function peripheral 10 monitors whether the update program is stored in the management server 40 (Step S102). When the update program is stored (or is uploaded) (Step S102; Yes), the multi function peripheral 10 obtains the information relating to the update program (the information indicating the contents to be improved, and the like) from the management server 40 (Step S103). It is not necessary that the update program is a program having the latest version. The update program may be a program having a newer version than the program stored in the multi function peripheral 10.

Next, the multi function peripheral 10 obtains the information of each job which is registered in the queue 70 (the information indicating the type of job and the setting contents) (Step S104). Then, the multi function peripheral 10 (MFP1) checks whether the job to be improved in which the quality of the job processing is improved more by being executed by another multi function peripheral 10 which operates in accordance with the update program, than by being executed by MFP1, is registered in the queue 70 (Step S105).

In case that the job to be improved is not registered in the queue 70 (Step S106; No), the process is ended. In this case, the jobs registered in the queue 70 are sequentially executed by the multi function peripheral 10 itself. When the execution of all of the jobs is finished and the multi function peripheral 10 is in the standby state, the update process for updating the stored program to the update program is carried out.

When the job to be improved is registered in the queue 70 (Step S106; Yes), the multi function peripheral 10 inquires of the management server 40 about whether another multi function peripheral 10 which already and normally operates in accordance with the update program and can be the transmission destination of the job to be improved (referred to as the available transmission destination) is provided on the network 2, or not (Step S107).

When the multi function peripheral 10 receives the response to the above inquiry, from the management server 40 (Step S108; Yes), the multi function peripheral 10 judges whether the above response indicates that the available transmission destination exists (Step S109). In case that the response from the management server 40 indicates “No available transmission destination” (Step S109; No), the process is ended. In this case, the job to be improved is not transmitted and is executed by the multi function peripheral 10 itself after the program is updated.

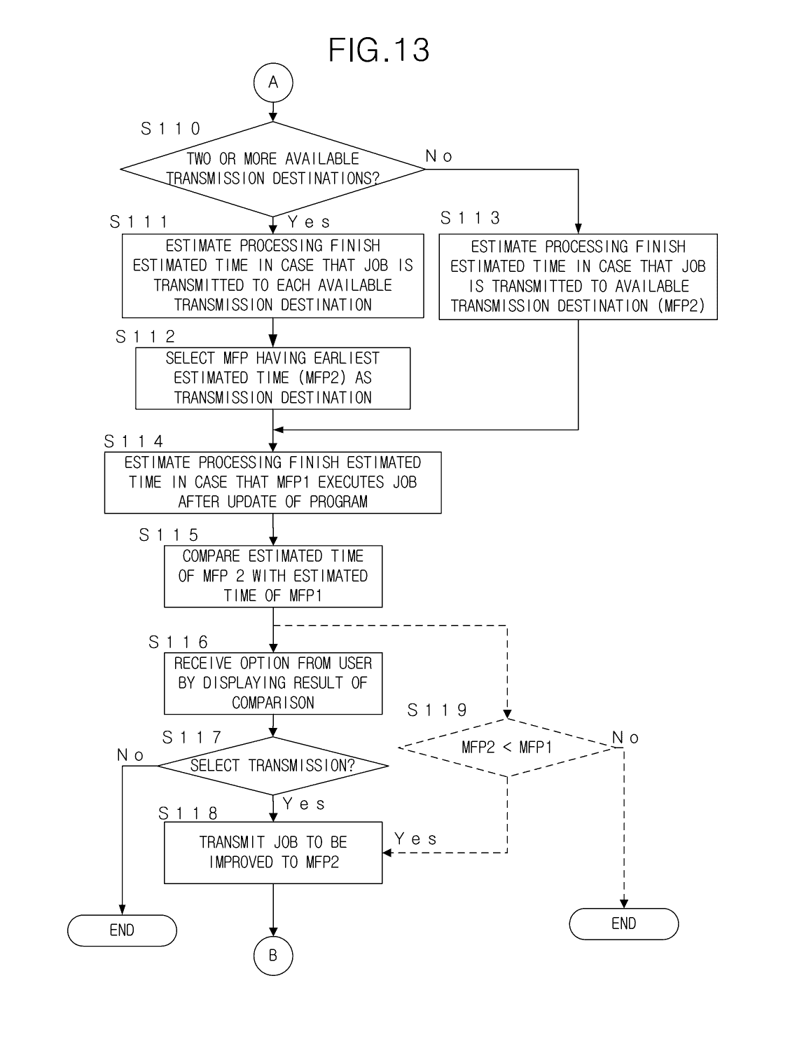

When the response from the management server 40 indicates “Available transmission destination exists” (Step S109; Yes), the multi function peripheral 10 judges whether the number of the available transmission destinations indicated in the response is two or more (Step S110 in FIG. 13).

In case that the number of the available transmission destinations is one (Step S110; No), the multi function peripheral 10 (MFP1) determines the available transmission destination indicated in the response from the management server 40, as the transmission destination of the job to be improved (referred to as “MFP2”). Then, the multi function peripheral 10 (MFP1) estimates the time at which the execution of the job to be improved is finished in case that the job to be improved is transmitted to MFP2 and is executed by MFP2 (first processing finish estimated time) (Step S113). The process proceeds to Step S114.

The processing finish estimated time is estimated in MFP1 by obtaining the information relating to the processing capability of the transmission destination, the number of jobs which are in the execution waiting state in the transmission destination, the size of the data to be processed and the like, from the transmission destination. Alternatively, the multi function peripheral 10 may notify the transmission destination of the information relating to the job to be improved, and instruct the transmission destination to calculate the processing finish estimated time. Then, the multi function peripheral 10 may obtain the calculated processing finish estimated time from the transmission destination.

In case that the number of the available transmission destinations is two or more (Step S110; Yes), the multi function peripheral 10 estimates each processing finish estimated time in case that the job to be improved is transmitted to each transmission destination, as described above (Step S111). Then, the multi function peripheral 10 selects the available transmission destination having the earliest processing finish estimated time, as the transmission destination of the job to be improved (referred to as “MFP2”) (Step S112). The process proceeds to Step S114.

In Step S114, the multi function peripheral 10 estimates the processing finish estimated time in case that MFP1 executes the job to be improved after the program of MFP1 is updated (second processing finish estimated time). Then, MFP1 compares the first processing finish estimated time with the second processing finish estimated time (Step S115).

In this case, when the multi function peripheral 10 (MFP1) is set so as to receive the option of the execution of the job by MFP1 itself or the transmission of the job to MFP2 from the user, MFP1 displays the result of the above comparison in Step S115 on the display unit 24 of the operation panel 23. Then, MFP1 receives the option of the execution of the job to be improved by MFP1 itself or the transmission of the job to be improved to MFP2 from the user (Step S116). In case that MFP1 receives the option of the execution of the job by MFP1 itself from the user (Step S117; No), the process is ended. In this case, the job to be improved is not transmitted and is executed by MFP1 itself after the program of MFP1 is updated.

In case that MFP1 receives the option of the transmission of the job to MFP2 from the user (Step S117; Yes), MFP1 transmits the job to be improved to MFP2 and instructs MFP2 to execute the job to be improved (Step S118).

In case that the setting for receiving the option from the user is invalided, that is, in case that the automatic selection is set, MFP1 compares the first processing finish estimated time in case that the job is executed by MFP2, with the second processing finish estimated time in case that MFP1 executes the job to be improved after the program of MFP1 is updated. When the first processing finish estimated time is earlier than the second processing finish estimated time (Step S119; Yes), the process proceeds to Step S118. The job to be improved is transmitted to MFP2.

In case that the first processing finish estimated time is not earlier than the second processing finish estimated time (Step S119; No), the process is ended. In this case, the job to be improved is not transmitted and is executed by MFP1 itself after the program of MFP1 is updated.

After Step S118, MFP1 requests MFP2 to confirm whether the job which can be executed in accordance with the old program (irrelevant job) is registered in the queue 70B of MFP2 (Step S121). In case that MFP1 receives the response indicating “No irrelevant job” from MFP2 (Step S122; Yes and Step S123; No), the process is ended.

In case that MFP1 receives the response indicating “Irrelevant job exists” from MFP2 (Step S122; Yes and Step S123; Yes), MFP1 instructs MFP2 to transmit the irrelevant job to MFP1 (Step S124). When MFP1 receives the irrelevant job from MFP2 (Step S125; Yes), MFP1 registers this irrelevant job in the queue 70A of MFP1 (Step S126). Then, the process is ended (End). The job received from MFP2 and registered in the queue 70A is executed by MFP1.

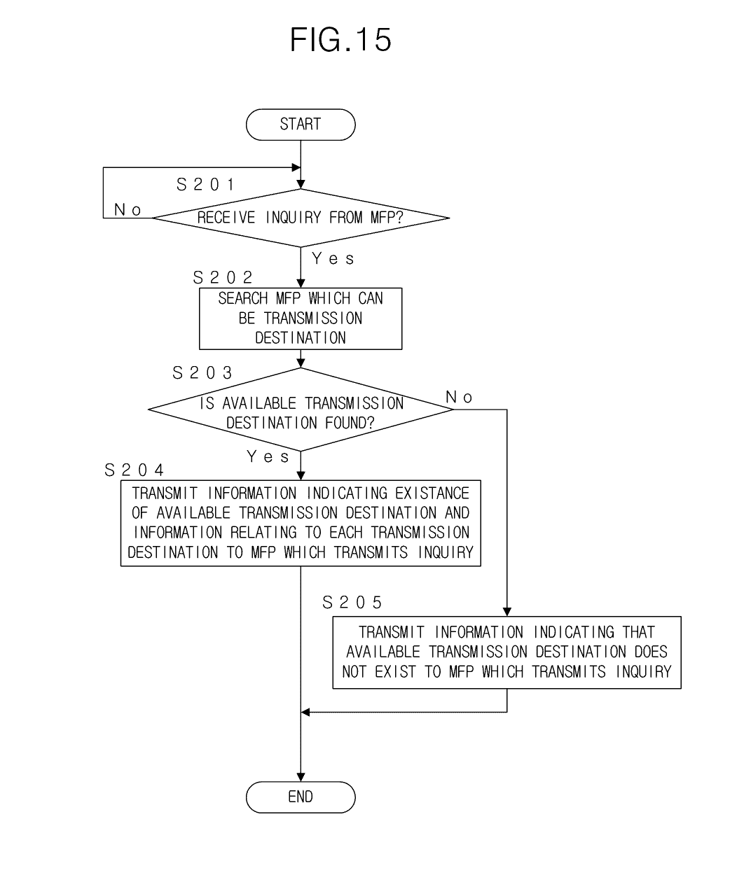

FIG. 15 shows the process carried out by the management server 40 so as to correspond to the process of the above multi function peripheral 10. When the management server 40 receives the inquiry about the available transmission destination from the multi function peripheral 10 (Step S201; Yes), the management server 40 searches another multi function peripheral which can be an available transmission destination on the network 2 (Step S202).

Specifically, the management server 40 which receives the above inquiry, refers to the update management table 65 and recognizes MFPs which operate in accordance with the program having the latest version (or a newer version than the program stored in MFP which transmits the inquiry). Then, the management server 40 detects all of the MFPs which can execute the job and are in operation among the recognized MFPs, as the available transmission destinations.

In case that the available transmission destination exists (Step S203; Yes), the management server 40 transmits the information indicating that the available transmission destination exists and the information relating to each transmission destination (the version of the program of each transmission destination, the situation of the jobs which are in the execution waiting state), to MFP which transmits the inquiry (Step S204). In case that the available transmission destination does not exist (Step S203; No), the management server 40 transmits the information indicating that the available transmission destination does not exist, to MFP which transmits the inquiry (Step S205).

Next, the operation of the multi function peripheral 10 in case that the job to be improved is not transmitted and is executed by the multi function peripheral 10 itself after the program is updated, will be explained.

Incase that the program is updated to upgrade the version thereof, there are a job in which the quality of the job processing is improved by updating the version (job to be improved) and a job in which the quality of the job processing is not changed regardless of whether the version of the program is upgraded or not (irrelevant job) among the jobs registered in the queue 70. In case of the irrelevant job, even if it takes several minutes to update the stored program to the update program, the update of the program is not advantageous to the irrelevant job. Conversely, the update of the program is disadvantageous to the irrelevant job because the time required for the update of the program is caused.

Therefore, in the multi function peripheral 10 according to the embodiment, in case that the irrelevant job exists in the queue 70, the multi function peripheral 10 is controlled as follows. The job order in the queue 70 is changed so as to execute the irrelevant jobs prior to the jobs to be improved. After the execution of all of the irrelevant jobs is finished, the program is updated. Then, the jobs to be improved are executed.

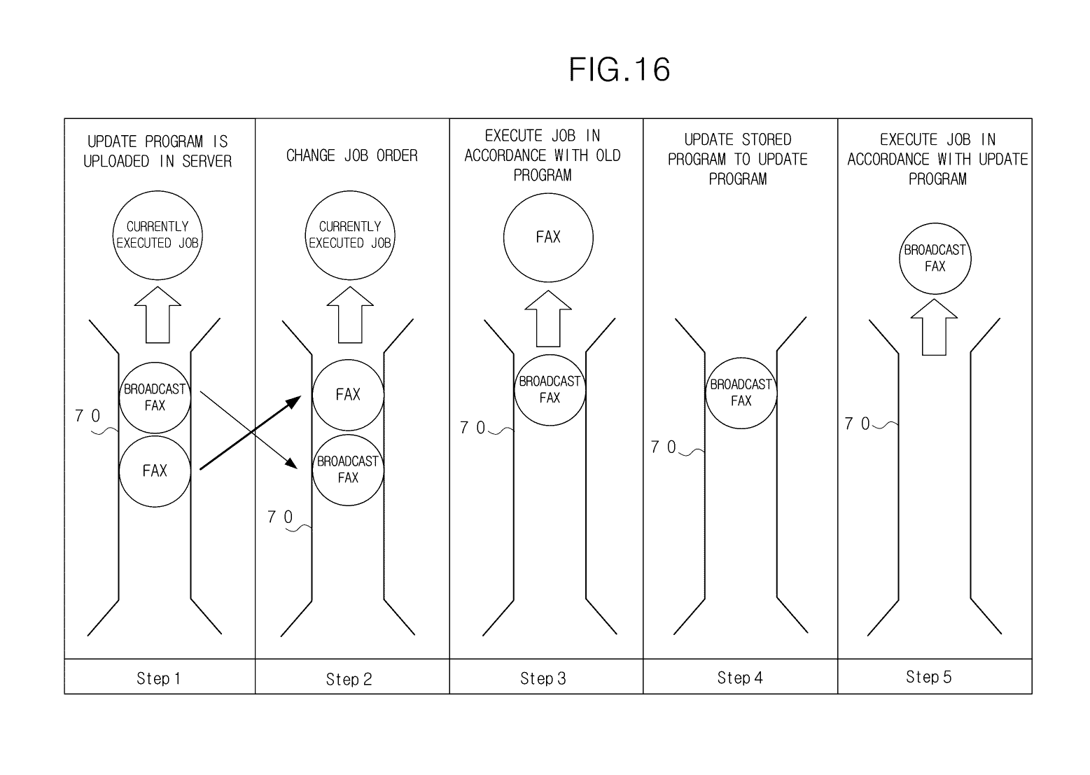

FIG. 16 shows the change in the state of the queue 70 in case that the multi function peripheral 10 is controlled as described above. As shown in Step 1 of FIG. 16, the facsimile broadcast transmission job which is the job to be improved is registered in the head of the queue 70. Further, behind the facsimile broadcast transmission job, the facsimile transmission job which is the irrelevant job is registered. At this time, when the update of the program is requested, such as when the update program is uploaded in the management server 40, or the like, as shown in Step 2, the job order is changed in the queue 70 so as to arrange the job to be improved behind all of the irrelevant jobs.

When the execution of the job which was being executed is finished, as shown in Step 3, all of the irrelevant jobs (facsimile transmission job) registered in the queue 70 are continuously executed in accordance with the old program. In case that a new job is entered in the queue 70 in this situation, the job order including the entered job is changed again. For example, when a new facsimile transmission job is entered, the job order is changed so as to arrange the entered job prior to the facsimile broadcast transmission job registered in the queue 70.

After the execution of all of the irrelevant jobs is finished and a job to be executed next (a job arranged in the head of the queue 70) is the facsimile broadcast transmission job which is the job to be improved (when the irrelevant job is not registered behind the job to be improved), as shown in Step 4, the execution of the next job is prohibited. Then, the update process for updating the old program to the update program is carried out. After the update process is finished, as shown in Step 5, the facsimile broadcast transmission job is executed in accordance with the update program.

As described above, because the job order is changed in the queue 70 so as to arrange the job to be improved behind all of the irrelevant jobs, even if the job to be improved is initially arranged prior to the irrelevant job in the queue 70, it is possible to update the stored program to the update program after all of the irrelevant jobs are executed.

Therefore, it is possible to effectively execute the irrelevant jobs sooner regardless of the initial job order in the queue 70 without requiring the processing time for updating the stored program to the update program. Further, after the execution of all of the irrelevant jobs is finished, the stored program is updated to the update program before the execution of the job to be improved. As a result, it is possible to execute the job to be improved in the situation in which the quality of the job processing is improved without the risk that the trouble is caused.

In the above operation, when the irrelevant jobs are successively entered, because the irrelevant jobs are executed firstly, the job to be improved cannot be executed soon. Therefore, the number of the jobs to be executed preferentially by changing the job order may be limited. Alternatively, the processing time for preferentially executing the jobs may be limited. When the above number or the above processing time exceeds the predetermined limitation, the job order is not further changed. In case that the update of the program is requested, after the execution of the job which was being executed is finished, the program may be immediately updated without changing the job order.

### Second Embodiment

In the second embodiment, the management server 40 judges the necessity of the transmission of the job and instructs the multi function peripheral 10 to transmit a job.

The management server 40 recognizes the version of the program of each multi function peripheral 10 and the contents to be improved, from the management table 60 and the update management table 65. Further, the management server 40 obtains the information of the jobs which are in the execution waiting state in the queue 70 of each multi function peripheral 10, from each multi function peripheral 10 connected via the network 2. Then, the management server 40 judges whether the job to be improved in which the quality of the job processing is improved by being executed by the multi function peripheral 10 which operates in accordance with the program having a newer version than the old program, is registered in the queue 70 of one peripheral function 10 which operates in accordance with the old program (referred to as “MFP1”) to detect the job to be improved (first job detection unit).

In case that the job to be improved is registered in the queue 70 of MFP1 which operates in accordance with the old program, the management server 40 instructs MFP1 to transmit the job to be improved to another multi function peripheral 10 which is provided on the network 2 and operates in accordance with the update program (referred to as “MFP2”), and instructs MFP2 to execute the transmitted job.

Only in case that the old program of MFP1 cannot be updated to the update program because MFP1 currently executes the job, the management server 40 may judge whether the job to be improved is registered among the jobs which are in the execution waiting state in the queue 70 of MFP1, to detect the job to be improved by the above first job detection unit.

Further, the management server 40 judges whether the job to be executed by the multi function peripheral 10 which operates in accordance with the update program (referred to as “MFP2”) is a job in which the quality of the job processing is not changed even by being executed in accordance with the old program (irrelevant job), to detect the irrelevant job (second job detection unit). In case that there is an irrelevant job among the jobs to be executed by MFP2, the management server 40 instructs MFP2 to transmit the irrelevant job to another multi function peripheral 10 which operates in accordance with the old program (referred to as “MFP1”), and instructs MFP1 to execute the transmitted job.

Only in case that the job to be improved is transmitted from MFP1, the management server 40 may judge whether the job to be executed by MFP2 is the irrelevant job, to detect and transmit the irrelevant job by the above second job detection unit.

The technology relating to the above operation of the management server 40 may be applied to the program for causing a server (information processing device) to function as the above management server 40.

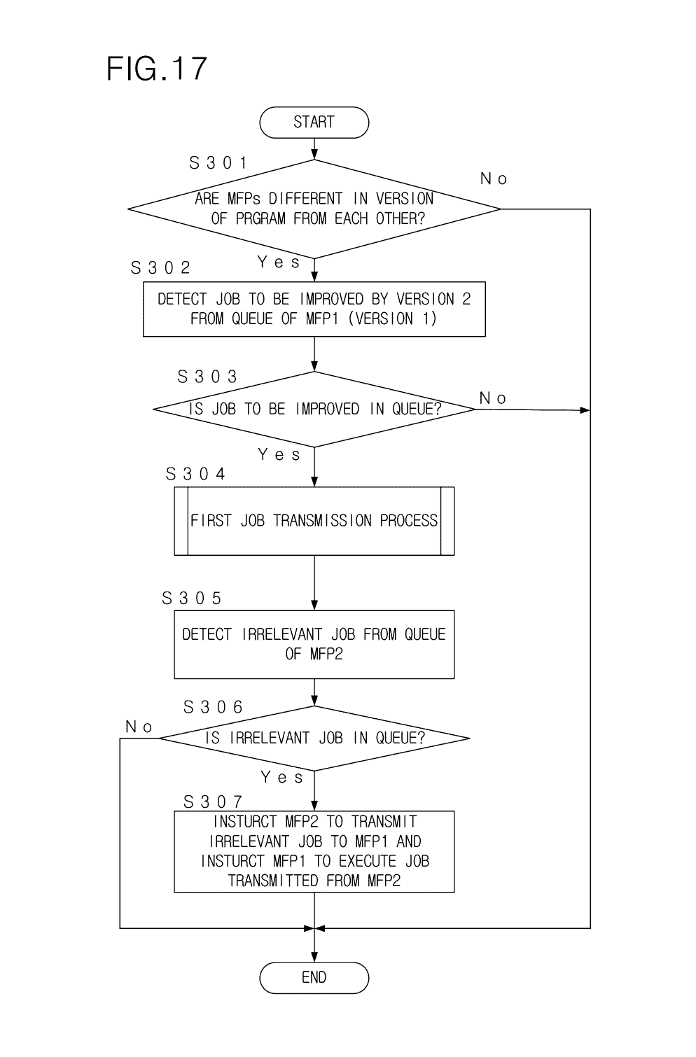

FIG. 17 shows the process for transmitting the job by the management server 40. The management server 40 confirms whether a plurality of multi function peripherals 10 which are managed by the management server 40 are different in the version of the program from each other, by referring to the update management server 65 (Step S301). When a plurality of multi function peripherals 10 which are managed by the management server 40 are the same in the version of the program (Step S301; No), the process is ended.

When a plurality of multi function peripherals 10 which are managed by the management server 40 are different in the version of the program from each other (Step S301; Yes), the management server 40 checks whether the job in which the quality of the job processing is improved by being executed by the multi function peripheral 10 which operates in accordance with the program having a new version than the old program (job to be improved) is registered in the queue 70 of the multi function peripheral 10 which operates in accordance with the old program (Step S302).

In this example, the multi function peripherals 10 which are managed by the management server 40 include a multi function peripheral 10 which operates in accordance with the program having the version number of 1 (version 1) and a multi function peripheral 10 which operates in accordance with the program having the version number of 2 (version 2). In this case, the management server 40 checks whether the job in which the quality of the job processing is improved by being executed by the multi function peripheral 10 which operates in accordance with the program having the version number of 2 is registered in the queue 70 of the multi function peripheral 10 which operates in accordance with the program having the version number of 1 (referred to as “MFP1”).

For example, the management server 40 specifies the type of the job to be improved (in case of FIG. 5, the facsimile broadcast transmission) by referring to the management table 60 and by comparing the contents to be improved by the version 1 with the contents to be improved by the version 2. Then, the management server 40 inquires of MFP1 about whether the specified type of job is registered in the queue 70 of MFP1 and confirms whether the job to be improved is registered, by receiving the response from MFP1. Each multi function peripheral 10 carries out the process shown in Steps S101 to S105 of FIG. 12 and in case that the job to be improved is registered in one multi function peripheral 10, the management server 40 may recognize the existence of the job to be improved, by being notified of the existence of the job to be improved. By another optional method, the management server may recognize the existence of the job to be improved.

In case that the job to be improved is not registered in the queue 70 of MFP1 (Step S303; No), the process is ended. In case that the job to be improved is registered in the queue 70 of MFP1 (Step S303; Yes), the management server 40 carries out the first job transmission process for transmitting the job to be improved to the multi function peripheral 10 which operates in accordance with the program having the version number of 2 to execute the job to be improved (Step S304).

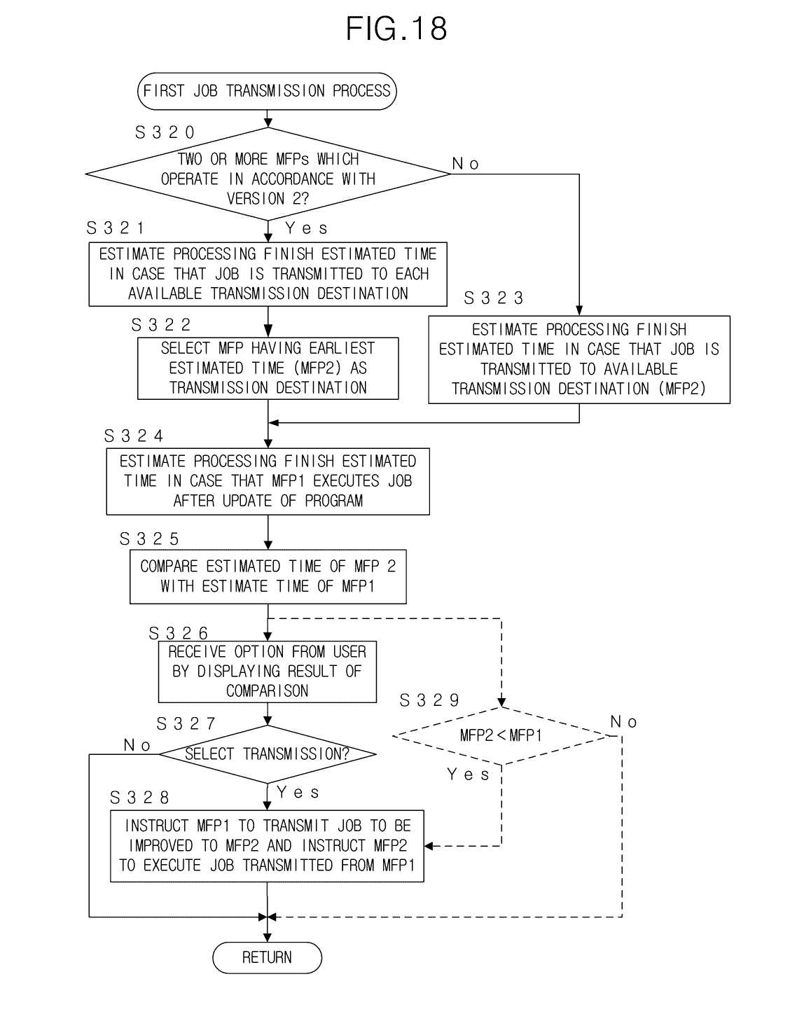

FIG. 18 shows the detail of the first job transmission process. Firstly, the management server 40 judges whether there are a plurality of multi function peripherals 10 which normally operates in accordance with the version 2 and can be the transmission destinations of the job to be improved (referred to as the available transmission destination) (Step S320). When the number of the available multi function peripherals 10 is only one (Step S320; No), the above available transmission destination is determined as the transmission destination of the job to be improved (referred to as “MFP2”). Then, the management server 40 estimates the time at which the execution of the job to be improved is finished in case that the job to be improved is transmitted to MFP2 and is executed by MFP2 (first processing finish estimated time) (Step S323). The process proceeds to Step S324.

The processing finish estimated time is estimated in the management server 40 by obtaining the information relating to the processing capability of the transmission destination, the number of jobs which are in the execution waiting state in the transmission destination, the size of the data to be processed and the like, from the transmission destination. Alternatively, the management server 40 may notify the transmission destination of the information relating to the job to be improved, and instruct the transmission destination to calculate the processing finish estimated time. Then, the management server 40 may obtain the calculated processing finish estimated time from the transmission destination.

In case that the number of the available transmission destinations is two or more (Step S320; Yes), the management server 40 estimates each processing finish estimated time in case that the job to be improved is transmitted to each available transmission destination, as described above (Step S321). Then, the management server 40 selects the available transmission destination having the earliest processing finish estimated time, as the transmission destination of the job to be improved (referred to as “MFP2”) (Step S322). The process proceeds to Step S324.

In Step S324, the management server 40 estimates the processing finish estimated time in case that MFP1 executes the job to be improved after the program of MFP1 is updated to the version 2 (second processing finish estimated time). Then, the management server 40 compares the first processing finish estimated time with the second processing finish estimated time (Step S325).

In this case, when the management server 40 is set so as to receive the option of the transmission of the job to MFP2 or the execution of the job by MFP1 without transmitting the job, from the user, the management server 40 notifies the user who enters the job to be improved (the user's terminal or the like) of the result of the above comparison in Step S325. Then, the management server 40 receives the option of the execution of the job to be improved by MFP1 or the transmission of the job to be improved to MFP2, from the user (Step S326). In case that the management server 40 receives the option of the execution of the job by MFP1 from the user (Step S327; No), the process is ended (Return). In this case, the job to be improved is not transmitted and is executed by MFP1 after the program of MFP1 is updated. For example, the job order is changed as shown in FIG. 16. Alternatively, the job order is not changed and the job to be improved is executed after the program is updated.

In case that the management server 40 receives the option of the transmission of the job to MFP2 from the user (Step S327; Yes), the management server 40 instructs MFP2 to execute the job to be improved, by transmitting the job to MFP2 (Step S328). Specifically, the management server 40 instructs MFP1 to transmit the job to be improved to MFP2 and instructs MFP2 to register the job to be improved, which is transmitted from MFP1, in the queue 70 to execute the job to be improved.

In case that the setting for receiving the option from the user is invalided, that is, in case that the automatic selection is set, the management server 40 compares the first processing finish estimated time in case that the job is executed by MFP2, with the second processing finish estimated time in case that MFP1 executes the job to be improved. When the first processing finish estimated time is earlier than the second processing finish estimated time (Step S329; Yes), the process proceeds to Step S328. The job to be improved is transmitted to MFP2.

In case that the first processing finish estimated time is not earlier than the second processing finish estimated time (Step S329; No), the process is ended (Return). In this case, the job to be improved is not transmitted and is executed by MFP1 after the program of MFP1 is updated.

The process returns to FIG. 17. After the first job transmission process, the management server 40 judges whether the job in which the quality of the job processing is maintained even if the job is executed by MFP1 (irrelevant job), is registered in the queue 70 of MFP2 (Step S305). For example, the management server 40 inquires of MFP2 about whether the irrelevant job is registered in the queue 70 of MFP2 and confirms the existence of the irrelevant job from the response of the above inquiry.

In case that the irrelevant job is not registered (Step S306; No), the process is ended. When the irrelevant job is registered (Step S306; Yes), the management server 40 instructs MFP1 to execute the irrelevant job by transmitting the irrelevant job to MFP1 (Step S307). Then, the process is ended. In detail, the management server 40 instructs MFP2 to transmit the irrelevant job to MFP1 and instructs MFP1 to register the irrelevant job which is transmitted from MFP2, in the queue 70 to execute the irrelevant job.

By the above second embodiment, the effect which is the same as that of the first embodiment can be obtained.

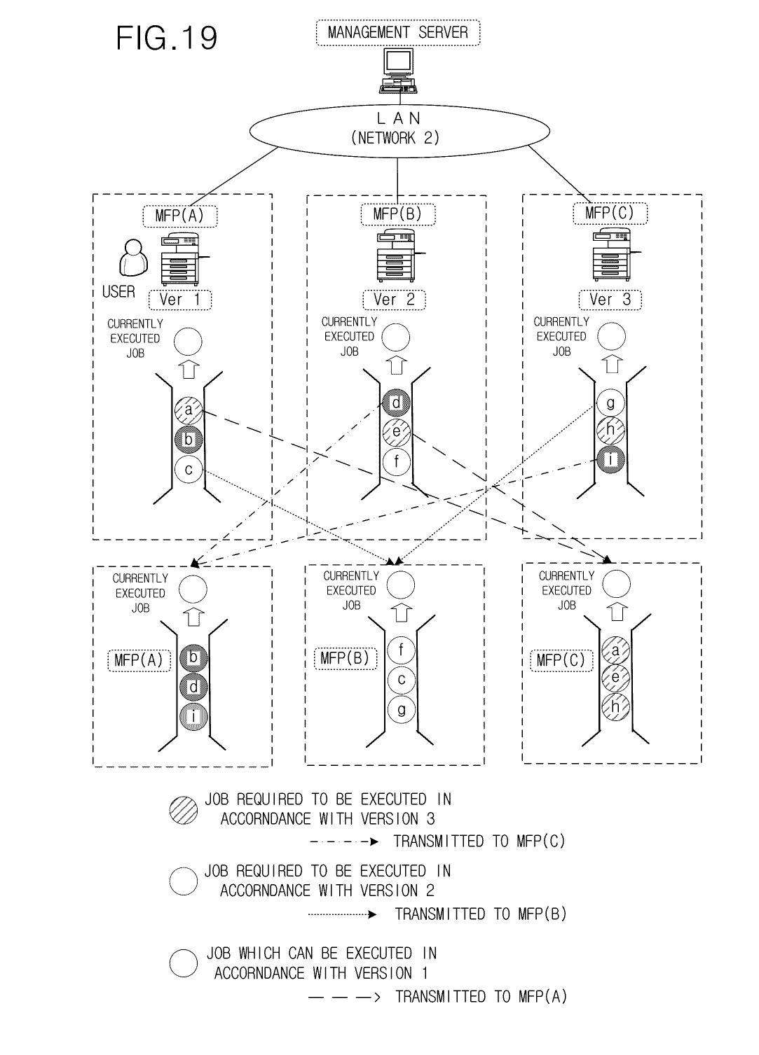

For example, as shown in FIG. 19, there are some cases in which MFP(A) which operates in accordance with the program having the version number of 1 (version 1), MFP(B) which operates in accordance with the program having the version number of 2 (version 2) and MFP(C) which operates in accordance with the program having the version number of 3 (version 3) are provided on the network. In this case, the job which is required to be executed in accordance with the version 3 in order to improve the quality of the job processing, is transmitted to MFP(C) from another MFP, the job which is required to be executed in accordance with the version 2 in order to improve the quality of the job processing, is transmitted to MFP(B) from another MFP, and the job in which the quality of the job processing is not influenced even if the job is executed in accordance with the version 1, is transmitted to MFP(A) from another MFP. As a result, it is possible to execute the jobs so as to improve the quality of the job processing of each job (or without causing the problem). Further, the processing load of each MFP is averaged.

It is necessary that the jobs a, e and h which are required to be executed in accordance with the version 3, are executed by MFP(C). The jobs c, f and g which are required to be executed in accordance with the version 2 can be executed by any one of MFP(B) and MFP(C). The jobs b, d and i in which the quality of the job processing is not influenced even if the job is executed in accordance with the version 1, can be executed by any one of MFP(A), MFP(B) and MFP(C). In this case, the jobs are transmitted as shown in FIG. 19 so as to maintain the quality of the job processing and average the processing load of each MFP.

For example, the transmission destination of each job may be determined as follows.

(1) In principle, each job is transmitted to MFP which operates in accordance with the program having the oldest version among MFPs which execute the job without influencing the quality of the job processing.

(2) In case that the processing load is biased by transmitting the jobs as described in the above (1), some of the jobs which are registered in MFP in which the processing load is large, are transmitted to MFP which operates in accordance with the program having a newer version and in which the processing load is small. Thereby, the processing load of each MFP is averaged.

The transmission destination of each job may be determined by the management server 40. Alternatively, each MFP may determine the transmission destination of each job registered in the queue thereof by exchanging the version information of the program and the job information with each other.

As described above, the embodiments are explained by using the drawings. However, in the present invention, the concrete configuration is not limited to the above embodiments. In the present invention, various modifications of the above embodiments or the addition of various functions or the like to the embodiments can be carried out without departing from the gist of the invention.

In the embodiments, the multi function peripheral 10 of the print system 5 is explained as an example of the job processing device. However, the job processing device is not limited to the multi function peripheral. The job processing device may be configured by extracting the CPU 11, the ROM 12, the nonvolatile memory 14, the network communication unit 20 and the image processing unit 16 from the multi function peripheral 10. The technology disclosed in the embodiments may be applied to the program for operating the multi function peripheral 10 as described in the embodiments.

The update program is not limited to the program having the latest version. The update program may be a program having a newer version than the old program.

The job may be also transmitted to another multi function peripheral 10 in a case other than the case in which the program cannot be updated soon because the job is currently executed although the update of the program is requested.

Further, in the embodiments, the management server 40 which is separated from the multi function peripheral 10 is explained as an example of the management server. However, any one of the multi function peripherals 10 may have the function of the management server 40.

One of the objects of the above embodiments is to provide a job processing device, a management server, a non-transitory computer-readable recording medium and a management method which can execute a job soon so as to maintain the quality of the job processing by effectively using another job processing device without waiting for the update of the program in one job processing device in case that one job processing device and another job processing device which operates in accordance with the program having a newer version than the program of one job processing device are provided.

In at least one of the embodiments, in case that there is another job processing device which operates in accordance with the program having a newer version than that of one job processing device, one job processing device transmits a job in which the quality of the job processing is improved more by being executed by another job processing device than by being executed by one job processing device itself, to another job processing device to instruct another job processing device to execute the job. Therefore, it is possible to execute the job soon so as to maintain the quality of the job processing by effectively using another job processing device without waiting for the update of the program in one job processing device.

In at least one of the embodiments, in case that there are a plurality of transmission destinations, the job processing device transmits a job to the transmission destination having the earliest processing finish estimated time of the transmitted job.

In at least one of the embodiments, the processing finish estimated time in case that the job to be transmitted is executed by transmitting the job to another job processing device, and the processing finish estimated time in case that the job is executed by one job processing device after the program of one job processing device is updated, are calculated and shown to a user. Then, the option of the transmission of the job or the execution of the job by one job processing device itself is received from the user.

In at least one of the embodiments, the processing finish estimated time in case that the job to be transmitted is executed by transmitting the job to another job processing device, and the processing finish estimated time in case that the job is executed by one job processing device after the program of one job processing device is updated, are calculated. When the former processing finish estimated time is earlier than the latter processing finish estimated time, the option “the transmission of the job” is automatically selected.

In at least one of the embodiments, the process for transmitting the job registered in the queue to another job processing device is carried out in case that the update of the program is delayed because the job is currently executed.

In at least one of the embodiments, after the job in which the advantage cannot be obtained by the update of the program is preferentially executed prior to the update of the program, the program is updated.

In at least one of the embodiments, in case that the job is transmitted from another job processing device, one job processing device exchanges the jobs with another job processing device by transmitting the job in which the problem is not caused by being executed by another job processing device, among the jobs registered in the queue of one job processing device.

In at least one of the embodiments, in case that the job in which the quality of the job processing is not deteriorated even if the job is executed by the first job processing device which operates in accordance with the old program, is registered in the queue of the second job processing device which operates in accordance with the new program, the above job is transmitted from the second job processing device to the first job processing device.

According to the job processing device, the management server, the non-transitory computer-readable recording medium and the management method, in case that one job processing device and another job processing device which operates in accordance with the program having a newer version than the program of one job processing device are provided, because the job which is in the execution waiting state in one job processing device and in which the quality of the job processing is improved by being executed by another job processing device, is transmitted to another job processing device to execute the job, it is possible to execute the job soon so as to maintain the quality of the job processing by effectively using another job processing device without waiting for the update of the program in one job processing device.

The present U.S. patent application claims the priority of Japanese Patent Application No. 2015-204959, filed on Oct. 16, 2015, according to the Paris Convention, and the entirety of which is incorporated herein by reference for correction of incorrect translation.

What is claimed is:

1. A job processing device, comprising:
a queue in which one or more jobs are stored;
a memory configured to store a program;
a network device configured to communicate with an external device via a network; and
a processor configured to:
sequentially execute the jobs stored in the queue, by operating in accordance with the program stored in the memory,
detect another job processing device which operates in accordance with a program having a newer version than the program stored in the memory, on the network,
detect a job in which a quality of a job processing is improved more by being executed by the detected another job processing device than by being executed by the job processing device itself, from the jobs stored in the queue, and
fetch the detected job from the queue and transmit the fetched job to the another job processing device via the network device to execute the transmitted job by the another job processing device.

2. The job processing device of claim 1, wherein the quality of the job processing includes at least one of an occurrence of a trouble, a productivity and an image quality.

3. The job processing device of claim 1, wherein when a plurality of the detected job processing devices which can be transmission destinations of the detected job are provided on the network, the processor estimates each processing finish estimated time in case that each detected job processing device which can be the transmission destination executes the detected job,
wherein the processor transmits the detected job to the detected job processing device having an earliest processing finish estimated time.

4. The job processing device of claim 1, wherein the processor is configured to:
calculate a first processing finish estimated time in case that the detected job is transmitted to the another job processing device to execute the transmitted job by the another job processing device and a second processing finish estimated time in case that the detected job is executed by the job processing device itself after the program of the job processing device is updated,
compare the first processing finish estimated time with the second processing finish estimated time,
notify a user of a result of comparing the first processing finish estimated time with the second processing finish estimated time, and receive an option of an execution of the detected job by the job processing device itself or a transmission of the detected job to the another job processing device, from the user, and
transmit the detected job to the another job processing device when the option of the transmission of the detected job is received from the user.

5. The job processing device of claim 1, wherein the processor is configured to:
calculate a first processing finish estimated time in case that the detected job is transmitted to the another job processing device to execute the transmitted job by the another job processing device and a second processing finish estimated time in case that the detected job is executed by the job processing device itself after the program of the job processing device is updated,
compare the first processing finish estimated time with the second processing finish estimated time, and
transmit the detected job to the another job processing device when the first processing finish estimated time is earlier than the second processing finish estimated time.

6. The job processing device of claim 1, wherein the processor is configured to:
update the program stored in the memory when the processor does not execute the job, and
detect the job in which the quality of the job processing is improved by being executed by the detected another job processing device, when an update of the program is delayed by executing the job.

7. The job processing device of claim 6, wherein when the job processing device itself executes the job in which the quality of the job processing is improved by being executed after the program is updated, the processor updates the program after the processor executes all of the jobs stored in the queue except the job in which the quality of the job processing is improved by being executed after the program is updated.

8. The job processing device of claim 1, wherein when the job processing device executes a job which is received from a second another job processing device which operates in accordance with a program having an older version than the program stored in the memory, the processor detects a second job in which the quality of the job processing is not deteriorated more by being executed by the second another job processing device than by being executed by the job processing device itself, from the jobs stored in the queue, and
the processor fetches the detected second job from the queue and transmits the fetched second job to the second another job processing device via the network device to execute the transmitted second job by the second another job processing device.

9. A management server which is connected with a plurality of job processing devices via a network, comprising:
a network device configured to communicate with at least a first job processing device which operates in accordance with a program having a first version and a second job processing device which operates in accordance with a program having a second version which is newer than the first version; and
a processor configured to:
detect a job which is in an execution waiting state in a queue of the first job processing device and in which a quality of a job processing is improved more by being executed by the second job processing device than by being executed by the first job processing device, and
instruct the first job processing device to transmit the detected job to the second job processing device to execute the transmitted job by the second job processing device.

10. The management server of claim 9, wherein the quality of the job processing includes at least one of an occurrence of a trouble, a productivity and an image quality.

11. The management server of claim 9, wherein when a plurality of the second job processing devices are provided on the network, the processor estimates each processing finish estimated time in case that each second job processing device executes the detected job,
wherein the processor instructs the first job processing device to transmit the detected job to the second job processing device having an earliest processing finish estimated time.

12. The management server of claim 9, wherein the processor is configured to:
calculate a first processing finish estimated time in case that the detected job is transmitted to the second job processing device to execute the transmitted job by the second job processing device and a second processing finish estimated time in case that the detected job is executed by the first job processing device after the program of the first job processing device is updated,
compare the first processing finish estimated time with the second processing finish estimated time,
notify a user of a result of comparing the first processing finish estimated time with the second processing finish estimated time, and receive an option of an execution of the detected job by the first job processing device or a transmission of the detected job to the second job processing device, from the user, and
instruct the first job processing device to transmit the detected job to the second job processing device when the option of the transmission of the detected job is received from the user.

13. The management server of claim 9, wherein the processor is configured to:
calculate a first processing finish estimated time in case that the detected job is transmitted to the second job processing device to execute the transmitted job by the second job processing device and a second processing finish estimated time in case that the detected job is executed by the first job processing device after the program of the first job processing device is updated,
compare the first processing finish estimated time with the second processing finish estimated time, and
instruct the first job processing device to transmit the detected job to the second job processing device when the first processing finish estimated time is earlier than the second processing finish estimated time.

14. The management server of claim 9, wherein the processor detects the job in which the quality of the job processing is improved by being executed by the second job processing device, when the program of the first job processing device cannot be updated by executing the job in the first job processing device.

15. The management server of claim 9, wherein the processor detects a second job in which the quality of the job processing is not deteriorated more by being executed by the first job processing device than by being executed by the second job processing device, from one or more jobs which are in an execution waiting state in the queue of the second job processing device, and
the processor instructs the second job processing device to transmit the detected second job to the first job processing device to execute the transmitted second job by the first job processing device.

16. The management server of claim 15, wherein when the first job processing device transmits the detected job to the second job processing device, the processor instructs the second job processing device to transmit the detected second job to the first job processing device to execute the transmitted job by the first job processing device.

17. A non-transitory computer-readable recording medium in which a management program is stored, wherein the management program causes a management server which is connected with a plurality of job processing devices via a network, to:
communicate with at least a first job processing device which operates in accordance with a program having a first version and a second job processing device which operates in accordance with a program having a second version which is newer than the first version;
detect a job which is in an execution waiting state in a queue of the first job processing device and in which a quality of a job processing is improved more by being executed by the second job processing device than by being executed by the first job processing device; and
instruct the first job processing device to transmit the detected job to the second job processing device to execute the transmitted job by the second job processing device.

18. The non-transitory computer-readable recording medium of claim 17, wherein the quality of the job processing includes at least one of an occurrence of a trouble, a productivity and an image quality.

19. The non-transitory computer-readable recording medium of claim 17, wherein when a plurality of the second job processing devices are provided on the network, the management server estimates each processing finish estimated time in case that each second job processing device executes the detected job,
wherein the management server instructs the first job processing device to transmit the detected job to the second job processing device having an earliest processing finish estimated time.

20. The non-transitory computer-readable recording medium of claim 17, wherein the management program further causes the management server to:
calculate a first processing finish estimated time in case that the detected job is transmitted to the second job processing device to execute the transmitted job by the second job processing device and a second processing finish estimated time in case that the detected job is executed by the first job processing device after the program of the first job processing device is updated,
compare the first processing finish estimated time with the second processing finish estimated time,
notify a user of a result of comparing the first processing finish estimated time with the second processing finish estimated time, and receive an option of an execution of the detected job by the first job processing device or a transmission of the detected job to the second job processing device, from the user, and
instruct the first job processing device to transmit the detected job to the second job processing device when the option of the transmission of the detected job is received from the user.

21. The non-transitory computer-readable recording medium of claim 17, wherein the management program further causes the management server to:
calculate a first processing finish estimated time in case that the detected job is transmitted to the second job processing device to execute the transmitted job by the second job processing device and a second processing finish estimated time in case that the detected job is executed by the first job processing device after the program of the first job processing device is updated,
compare the first processing finish estimated time with the second processing finish estimated time, and
instruct the first job processing device to transmit the detected job to the second job processing device when the first processing finish estimated time is earlier than the second processing finish estimated time.

22. The non-transitory computer-readable recording medium of claim 17, wherein the management server detects the job in which the quality of the job processing is improved by being executed by the second job processing device, when the program of the first job processing device cannot be updated by executing the job in the first job processing device.

23. The non-transitory computer-readable recording medium of claim 17, wherein the management program further causes the management server to:
detect a second job in which the quality of the job processing is not deteriorated more by being executed by the first job processing device than by being executed by the second job processing device, from one or more jobs which are in an execution waiting state in the queue of the second job processing device, and
instruct the second job processing device to transmit the detected second job to the first job processing device to execute the transmitted second job by the first job processing device.

24. A management method, comprising:
communicating with at least a first job processing device which operates in accordance with a program having a first version and a second job processing device which operates in accordance with a program having a second version which is newer than the first version;
detecting a job which is in an execution waiting state in a queue of the first job processing device and in which a quality of a job processing is improved more by being executed by the second job processing device than by being executed by the first job processing device; and
instructing the first job processing device to transmit the detected job to the second job processing device to execute the transmitted job by the second job processing device.
